(19) United States
(12) Patent Application Publication
(10) Pub. No.: US 2022/0313533 A1
(43) Pub. Date: Oct. 6, 2022

(54) MULTIANGLE FOOT POSITIONING DEVICE

(71) Applicant: Waleed Al-Oboudi, San Diego, CA (US)

(72) Inventor: Waleed Al-Oboudi, San Diego, CA (US)

(21) Appl. No.: 17/657,908

(22) Filed: Apr. 4, 2022

Related U.S. Application Data
(60) Provisional application No. 63/170,939, filed on Apr. 5, 2021.

(51) Int. Cl. A61H 1/02

(52) U.S. Cl. CPC A61H 1/0266; A61H 2201/1642; A61H 2201/1671

(57) ABSTRACT

A multiangle foot positioning device is disclosed. The multiangle foot positioning device can include a foot plate configured to receive a user's foot, a base plate, and an angle adjustment mechanism attached to and extending between the foot plate and the base plate and configured to allow an angle between the foot plate and the base plate to be adjusted. The angle can be adjusted to position the foot in a dorsiflexed or plantar flexed position. The angle can be adjusted to position the foot in an inverted or everted positioned.

### PRIORITY APPLICATION(S)

This application claims priority to U.S. Provisional Application No. 63/170,939, filed Apr. 5, 2021, which is incorporated herein bey reference. Any and all applications for which a foreign or domestic priority claim is identified in the Application Data Sheet as filed with the present application are hereby incorporated by reference under 37 CFR 1.57.

### BACKGROUND

### Field

This application relates generally to orthotic, therapeutic, and stretching devices, and in particular, to a multiangle foot positioning device configured to help a user stretch his or her foot in dorsiflexion, plantar flexion, eversion, and/or inversion.

### Description

Ankle and foot mobility is important for posture and movement. Restricted ankle or foot mobility can cause a host of problems that can affect the entire body. Modern living, which frequently involves sitting for long periods of times, can lead to tight calf muscles and/or other problems that limit ankle and foot mobility. Accordingly, there is a need for a device that can be used as a therapy aid to help users recover or improve ankle and foot mobility.

### SUMMARY

The multiangle foot positioning systems, methods and devices described herein have innovative aspects, no single one of which is indispensable or solely responsible for their desirable attributes. Without limiting the scope of the claims, some of the advantageous features will now be summarized.

A multiangle foot positioning device can be configured for positioning a foot of a user in various angles depending selected to provide stretching or a passive range of motion. In some embodiments, the device can be used in sitting, for example, while working at a desk. In other embodiments, the device can be used with the user in a supine position. The device can be configured for use by either foot. The device can include a foot plate and a base plate with an angle adjustment mechanism therebetween. The angle of the foot plate can be set and fixed in place.

In a first aspect, a foot positioning device can include a foot plate configured to receive a user's foot and a base plate. An angle adjustment mechanism attached to and extending between the foot plate and the base plate is configured to allow an angle between the foot plate and the base plate to be adjusted.

In some embodiments, the angle can be adjusted to position the foot in a dorsiflexed or plantar flexed position. In some embodiments, the angle can be adjusted to position the foot in an inverted or everted positioned. In some embodiments, the angle can be adjusted to position the foot in one of a dorsiflexed or plantar flexed position, and one of an inverted or everted position. In some embodiments, the angle adjustment mechanism comprises a base attached to the base plate, a cover pivotally attached to the base, a ball received between the cover and the base, an arm extending from the ball and attached to the foot plate, and a tightening mechanism configured to be tightened to fix the position of the ball between the cover and the base.

In another aspect, a method for positioning a foot can include positioning a user's foot on a foot plate, wherein the foot plate is adjustably positionable relative to a base plate using an angle adjustment mechanism; adjusting the angle adjustment mechanism to a desired angle between the foot plate and the base plate; and fixing the angle adjustment mechanism in position.

In some embodiments, the angle can be adjusted to position the foot in a dorsiflexed or plantar flexed position. In some embodiments, the angle can be adjusted to position the foot in an inverted or everted positioned. In some embodiments, the angle can be adjusted to position the foot in one of a dorsiflexed or plantar flexed position, and one of an inverted or everted position. In some embodiments, the angle adjustment mechanism comprises a base attached to the base plate, a cover pivotally attached to the base, a ball received between the cover and the base, an arm extending from the ball and attached to the foot plate, and a tightening mechanism configured to be tightened to fix the position of the ball between the cover and the base.

### BRIEF DESCRIPTION OF THE DRAWINGS

The above-mentioned aspects of the multiangle foot positioning systems, methods, and devices described herein, as well as other features, aspects, and advantages of the present technology will now be described in connection with various embodiments, with reference to the accompanying drawings. The illustrated embodiments, however, are merely examples and are not intended to be limiting. Like reference numbers and designations in the various drawings indicate like elements.

FIGS. 1 and 2 illustrate views of an embodiment of a multiangle foot positioning device. In the illustrated embodiment, the device includes a foot plate, a base plate, and an angle adjustment mechanism attached to and extending between the foot plate and the base plate is configured to allow an angle between the foot plate and the base plate to be adjusted.

FIG. 1 is a side view of the multiangle foot positioning device.

FIG. 2 is a top view of the multiangle foot positioning device.

FIGS. 3 and 4 illustrate view of the multiangle foot positioning device during use with a foot of the user supported on the foot plate.

FIG. 3 is a side view of the multiangle foot positioning device during use.

FIG. 4 is a top view of the multiangle foot positioning device during use.

### DETAILED DESCRIPTION

This application is directed to a multiangle foot positioning device. The multiangle foot positioning device can be configured for positioning a foot of a user in various angles depending selected to provide stretching or a passive range of motion. In some embodiments, the device can be used in sitting, for example, while working at a desk. In other embodiments, the device can be used with the user in a supine position. The device can be configured for use by either foot. The device can include a foot plate and a base plate with an angle adjustment mechanism therebetween. The angle of the foot plate can be set and fixed in place.

In the following detailed description, reference is made to the accompanying drawings, which form a part of the present disclosure. These illustrative embodiments are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and form part of this disclosure.

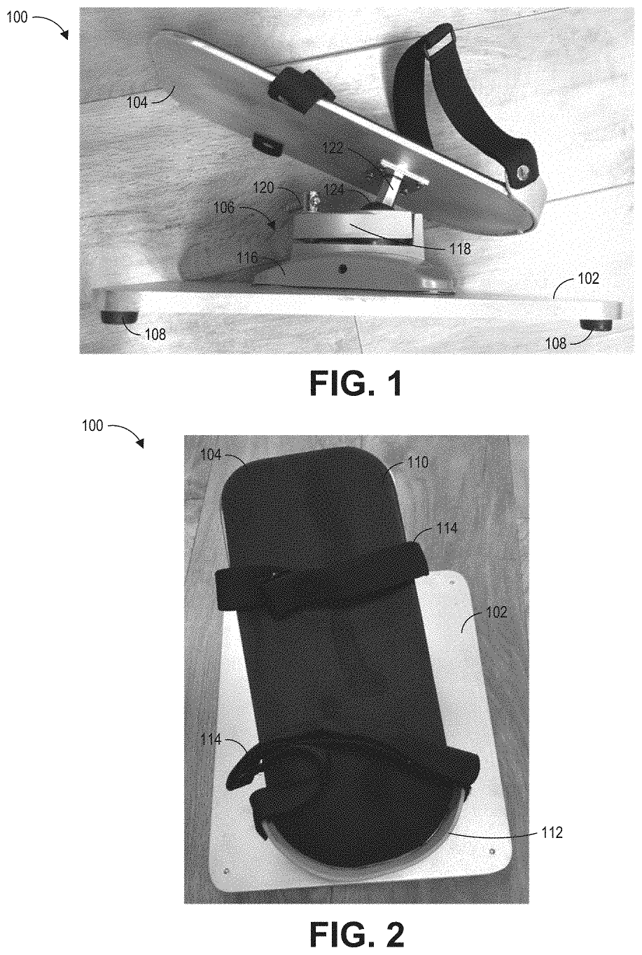

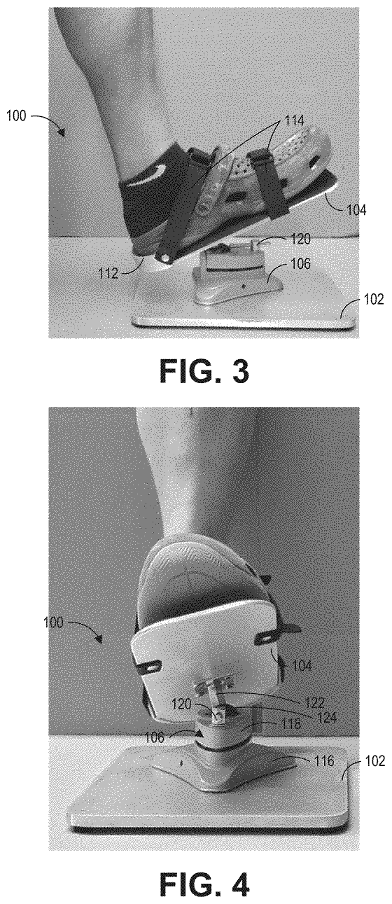

FIGS. 1 and 2 illustrate views of an embodiment of a multiangle foot positioning device 100. In the illustrated embodiment, the device includes a foot plate 104, a base plate 102, and an angle adjustment mechanism 106 attached to and extending between the foot plate 104 and the base plate 104 that is configured to allow an angle between the foot plate 104 and the base plate 102 to be adjusted. FIGS. 3 and 4 illustrate views of the multiangle foot positioning device 100 during use with a foot of the user supported on the foot plate 104.

With reference to FIGS. 1 and 2, an example multiangle foot positioning device 100 will be described. Afterwards, with reference to FIGS. 3 and 4 an example use of the multiangle foot positioning device 100 will be described. As noted previously, the illustrated examples are provided by way of illustration and should not be construed as limiting. Those of ordinary skill in the art, upon consideration of this disclosure, will appreciate that various modifications are possible.

As shown in FIGS. 1 and 2, the foot positioning device 100 includes a base plate 102, a foot plate 104, and angle adjustment mechanism 106. In general, the base plate 102 is configured to support the foot positioning device 100, the foot plate 104 is configured to support one of the user's feet, and the angle adjustment mechanism 106 is configured to allow an angle between the foot plate 104 and the base plate 102 to be adjusted and fixed.

In the illustrated embodiment, the base plate 102 comprise a planar plate. Other shapes (e.g., non-planar shapes) for the base plate 102 are possible as long as the base plate 102 provides a suitable and stable mechanism for supporting the foot positioning device 100. In general, the base plate 102 supports the foot positioning device 100 relative to a supporting surface such as the ground or other surface on which the base plate 102 rests. In the illustrated embodiment, the base plate 102 includes feet 108 attached to a bottom side thereof. The feet 108 can be rubberized (or other suitable) feet configured to prevent the base plate 102 from marring the surface on which it rests and/or to improve the traction or friction between the base plate 102 and surface on which the base plate 102 rests. In some embodiments, the feet 108 can be omitted.

The base plate 102 can comprise a rigid material. In some embodiments, the base plate 102 comprises steel, aluminum, or other suitable metals or alloys. In some embodiments, the base plate 102 may comprise plastic. In some embodiments, the base plate 102 may be weighted (or have sufficient weight) to add stability to the foot positioning device 100. This can, for example, make the foot positioning device 100 stable during use and prevent the foot positioning device 100 from tipping over during use.

With continued reference to FIGS. 1 and 2, the foot plate 104 can be configured to receive and support a user's foot, for example, an upper surface thereof. Accordingly, the foot plate 104 may be configured in size and shape for receiving a user's foot. In some embodiments, during use, the foot plate 104 extends entirely under the user's foot. In some embodiments, during use, the foot plate 104 extends only partially under the user's foot, leaving a portion of the user's foot unsupported. In the illustrated embodiment, the foot plate 104 is generally planar, although this need not be the case in all embodiments. For example, the foot plate 104 can be contoured to match the contours of the user's foot. In some embodiments, the foot plate 104 is provided with an ambidextrous shape that is suitable for use by either the user's right or left foot. The foot plate 104 can comprise a rigid material. In some embodiments, the foot plate 104 comprises steel, aluminum, or other suitable metals or alloys. In some embodiments, the base plate 104 may comprise plastic.

As shown in FIGS. 1 and 2, in some embodiments, the foot plate 104 comprises a cushion and/or friction surface, pad, or other material 110, attached to the upper surface thereof. For example, a layer of foam or rubber can be included on the upper surface of the foot plate 104. This may, for example, increase the overall comfort of the foot positioning device 100. Additionally or alternatively, the foot plate 104 can include one more straps 114 configured to secure the user's foot to the foot plate. In the illustrated embodiment, two straps 114 are included, although other numbers of straps 114 may be used in other embodiments. In the illustrated embodiment, the foot plate 104 also includes a heel cup 112 positioned on the heel end of the foot plate 104. The heel cup 112 may help the user position his or her foot on the foot plate 104 and keep the foot from sliding off of the foot plate 104.

An angle adjustment mechanism 106 in included between the base plate 102 and the foot plate 104. The angle adjustment mechanism 106 is configured to allow an angle of the foot plate 104 to be adjusted relative to the base plate 102. For example, the foot plate 104 can be positioned at a desired angle (e.g., for therapeutic stretching) and then set in place using the angle adjustment mechanism 106. The user can then rest his or her foot on the foot plate 104 for stretching.

Various angle adjustment mechanisms 106 are possible. In the illustrated embodiment, the angle adjustment mechanism 106 includes a base 116, a cover 118, a tightening mechanism 120, an arm 122, and a ball 124. The base 116 can be fixed to the base plate 102. The cover 118 can be hingedly connected to the base 116. Between the base 116 and the cover 118 a recess can be formed for receiving the ball 124, such that the ball 124 is positioned between the base 116 and the cover 118. The arm 122 extends from the ball 124 and attaches to the foot plate 104. When the tightening mechanism 120 is loosened, the position of the ball 124 can be adjusted, thereby adjusting the angle of the foot plate 104. Once positioned as desired, the tightening mechanism 120 can be tightened, locking the ball 124 and thereby the angle of the foot plate 104 in position. In the illustrated embodiment, the tightening mechanism 120 comprises a screw or other fastener that tightens the cover 118 to the base 116 to limit movement of the ball 124.

FIGS. 3 and 4 illustrate the foot positioning device 100 during use. As shown, a user can set the angle of the foot plate 104 to a desired position and fix it into place. The user can then position his or her foot on the foot plate 104 and secure the foot using the straps 114. The user can then rest his or her foot on the foot plate 104 and, due to the angle of the device, receive passive stretching. In some embodiments, the angle can be adjusted to position the foot in a dorsiflexed or plantar flexed position. In some embodiments, the angle can be adjusted to position the foot in an inverted or everted positioned. In some embodiments, the angle can be adjusted to position the foot in one of a dorsiflexed or plantar flexed position, and one of an inverted or everted position. Accordingly, the foot positioning device 100 can be considered a multiangle device as it is capable of positioning the foot at a plurality of different angles.

The device 100 beneficially provides a readily adjustable surface (the foot plate 104) that can be positioned at a high number of therapeutic angles that can be used to stretch the foot, ankle, and/or leg. This can be useful in increasing the range of motion of the foot or ankle. Further, the device 100 is simple to use, and can even be used under a desk, for example, while working.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate that direction terms, such as “upper” and “lower,” are sometimes used for ease of describing the figures, and indicate relative positions corresponding to the orientation of the figure on a properly oriented page, and may not reflect the proper orientation of the device as implemented.

Certain features that are described in this specification in the context of separate implementations also can be implemented in combination in a single implementation. Conversely, various features that are described in the context of a single implementation also can be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

In describing the present technology, the following terminology may have been used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3 and 4 and sub-ranges such as 1-3, 2-4 and 3-5, etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

Elements that are described as “connected,” “engaged,” “attached,” or similarly described, shall include being directly and/or indirectly connected, engaged, attached, etc.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Conjunctions, such as “and,” “or” are used interchangeably and are intended to encompass any one element, combination, or entirety of elements to which the conjunction refers.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. Accordingly, the scope of the present invention is intended to be defined only by the claims that follow.

What is claimed is:

1. A foot positioning device comprising:
a foot plate configured to receive a user's foot;
a base plate; and
an angle adjustment mechanism attached to and extending between the foot plate and the base plate and configured to allow an angle between the foot plate and the base plate to be adjusted.

2. The foot positioning device of claim 1, wherein the angle can be adjusted to position the foot in a dorsiflexed or plantar flexed position.

3. The foot positioning device of claim 1, wherein the angle can be adjusted to position the foot in an inverted or everted positioned.

4. The foot positioning device of claim 1, wherein the angle can be adjusted to position the foot in:
one of a dorsiflexed or plantar flexed position; and
one of an inverted or everted position.

5. The foot positioning device of claim 1, wherein the angle adjustment mechanism comprises:
a base attached to the base plate;
a cover pivotally attached to the base;
a ball received between the cover and the base;
an arm extending from the ball and attached to the foot plate; and
a tightening mechanism configured to be tightened to fix the position of the ball between the cover and the base.

6. A method for positioning a foot, the method comprising:
positioning a user's foot on a foot plate, wherein the foot plate is adjustably positionable relative to a base plate using an angle adjustment mechanism;
adjusting the angle adjustment mechanism to a desired angle between the foot plate and the base plate; and
fixing the angle adjustment mechanism in position.

7. The method of claim 6, wherein the angle can be adjusted to position the foot in a dorsiflexed or plantar flexed position.

8. The method of claim 6, wherein the angle can be adjusted to position the foot in an inverted or everted positioned.

9. The method of claim 6, wherein the angle can be adjusted to position the foot in:
one of a dorsiflexed or plantar flexed position; and
one of an inverted or everted position.

10. The method of claim 6, wherein the angle adjustment mechanism comprises:
a base attached to the base plate;
a cover pivotally attached to the base;
a ball received between the cover and the base;
an arm extending from the ball and attached to the foot plate; and
a tightening mechanism configured to be tightened to fix the position of the ball between the cover and the base.
